(19) United States
(12) Patent Application Publication
(10) Pub. No.: US 2025/0282595 A1
(43) Pub. Date: Sep. 11, 2025

(54) PILE DISTRIBUTION VEHICLE AND ATTACHMENT

(71) Applicant: M. A. Mortenson Company, Minneapolis, MN (US)

(72) Inventors: Trent P. Mostaert, Minneapolis, MN (US); Benjamin Peterson, Minneapolis, MN (US); Anthony Faught, Minneapolis, MN (US); Mark Tiegs, West Allis, WI (US)

(21) Appl. No.: 19/073,536

(22) Filed: Mar. 7, 2025

Related U.S. Application Data
(60) Provisional application No. 63/563,105, filed on Mar. 8, 2024.

(51) Int. Cl. B66F 9/18; B66F 9/075; B66F 9/22

(52) U.S. Cl. CPC B66F 9/18; B66F 9/07504; B66F 9/22

(57) ABSTRACT

A removable attachment for a vehicle includes a coupling portion including at least one coupling member configured to removably coupled to the vehicle, a material support portion extending from the coupling portion and defining a surface configured to receive cargo, a distribution assembly extending from one of the material support portion and the coupling portion, wherein the distribution assembly includes a moveable arm operable to provide movement along at least two axes, and a coupler extending from the moveable arm, wherein the coupler is positioned to selectively engage and disengage an object for unloading from the material support portion.

### CROSS REFERENCE TO RELATED APPLICATIONS

This application claims priority to U.S. Provisional Application No. 63/563,105, filed on Mar. 8, 2024, the disclosure of which is hereby incorporated by reference in its entirety.

### FIELD

The present disclosure relates generally to apparatuses, systems, and methods for distributing supplies at a work site. More specifically, the disclosure relates to apparatuses, systems, and methods capable of efficiently distributing materials such as piles at intervals over a large area.

### BACKGROUND

The typical process for distributing piles (e.g., piles for supporting solar arrays) at a work site (e.g., construction site for a solar field) includes using heavy equipment in combination with manual labor. In any given project, there are different type of piles for various purposes. For example, in a solar field, the piles may include arrays of interior piles, damper piles, motor piles, inverter piles, etc. In this example, interior piles comprise the majority of piles that are implemented in the construction of a solar field (e.g., about 70%-75%). In general, the fewer pile types implemented in a given project will result in a simpler distribution operation, but may include a higher cost of material. A project team coordinates with a supplier to plan for an anticipated bundle size for each pile type.

The traditional way of distributing the various piles is performed using a skid steer and a three-person crew. The first crew member is responsible for operating the skid steer. The two remaining crew members are responsible for lifting each pile and placing it on the ground. The operator is responsible for backing up the skid steer in this operation and relies on a survey crew for the pin placement of the pile. An alternative traditional method is to utilize a tractor pulling a pile distribution trailer. One crew member is responsible for driving the tractor while an additional two crew members are in the distribution trailer. The additional crew members throw a pile off the side of the distribution trailer as they near the location of a survey pin previously placed by the survey crew.

### SUMMARY

A vehicle and an associated attachment are provided for efficient distribution of materials at a large worksite.

According to one example (“Example 1”), a removable attachment configured to be removably coupled to a vehicle for distribution of a plurality objects at a worksite is provided. The vehicle includes an accessory coupling mount and a hydraulic pressure source. The removable attachment includes a coupling portion including at least one coupling member configured to be removably coupled to the accessory coupling mount of the vehicle; a material support portion extending from the coupling portion, the material support portion defining a surface operable to support the objects during movement of the vehicle; and a distribution arm assembly extending from one of the material support portion and the coupling portion. The distribution arm assembly includes a first arm extending in a first direction, a first hydraulic actuator coupled to the first arm and operable to linearly translate at least a portion of the first arm, the first hydraulic actuator fluidly coupled to the hydraulic pressure source, a second arm extending from the first arm generally in a second direction that is different from the first direction, a second hydraulic actuator coupled to the second arm and operable to linearly translate at least a portion of the second arm, the second hydraulic actuator fluidly coupled to the hydraulic pressure source, and a coupler extending from the second arm, wherein the coupler is positioned to selectively interface an object of the plurality of objects.

According to another example (“Example 2”), further to Example 1, the coupler is electromagnetic and wherein the coupler is configured to electrically couple to an electrical system of the vehicle.

According to another example (“Example 3”), further to Example 1, the material support portion includes at least two forks extending generally horizontally.

According to another example (“Example 4”), further to Example 1, the second arm of the distribution assembly supports a camera.

According to another example (“Example 5”), further to Example 1, the distribution assembly includes a harness operable to maintain hydraulic and electrical lines.

According to another example (“Example 6”), further to Example 5, the harness includes a plurality of couplers operable to couple to the hydraulic pressure source and an electrical system of the vehicle.

According to another example (“Example 7”), further to Example 1, the removable attachment further comprises a manifold system fluidically coupled to the first hydraulic actuator and the second hydraulic actuator and operable to coupled to the hydraulic pressure source of the vehicle.

According to another example (“Example 8”), further to Example 1, the removable attachment further comprises a control system operable to control the distribution assembly and configured to be electrically coupled to an electrical system of the vehicle.

According to an example (“Example 9”), a vehicle for distribution of a plurality objects at a worksite is provided. The vehicle includes a plurality of ground engaging members; a frame supported by the ground engaging members; a powertrain assembly supported by the frame and operably coupled to at least one of the ground engaging members; a hydraulic pressure source supported by the frame and including a coupling member; an accessory coupling mount supported by the frame; and a removable attachment assembly supported by the frame. The removable attachment assembly includes a coupling portion including at least one coupling member configured to removably coupled to the accessory coupling mount of the vehicle; a material support portion extending from the coupling portion, the material support portion defining a surface operable to support the objects during movement of the vehicle; and a distribution assembly extending from one of the material support portion and the coupling portion. The distribution assembly includes a first arm extending in a first direction, a first hydraulic actuator coupled to the first arm and operable to linearly translate at least a portion of the first arm, the first hydraulic actuator fluidly coupled to the hydraulic pressure source, a second arm extending from the first arm generally in a second direction that is different from the first direction, a second hydraulic actuator coupled to the second arm and operable to linearly translate at least a portion of the second arm, the second hydraulic actuator fluidly coupled to the hydraulic pressure source, and a coupler extending from the second arm, wherein the coupler is positioned to selectively interface an object of the plurality of objects.

According to another example (“Example 10”), further to Example 9, the coupler is electromagnetic and wherein the coupler is configured to electrically couple to an electrical system of the vehicle.

According to another example (“Example 11”), further to Example 9, the material support portion includes at least two forks extending generally horizontally.

According to another example (“Example 12”), further to Example 9, the second arm of the distribution assembly supports a camera.

According to another example (“Example 13”), further to Example 9, the distribution assembly includes a harness operable to maintain hydraulic and electrical lines.

According to another example (“Example 14”), further to Example 13, the harness includes a plurality of couplers operable to couple to the hydraulic pressure source and an electrical system of the vehicle.

According to another example (“Example 15”), further to Example 9, the vehicle includes a manifold system fluidically coupled to the first hydraulic actuator and the second hydraulic actuator and operable to coupled to the hydraulic pressure source of the vehicle.

According to another example (“Example 16”), further to Example 9, the vehicle includes a control system operable to control the distribution assembly and configured to be electrically coupled to an electrical system of the vehicle.

According to one example (“Example 17”), a removable attachment for a vehicle is provided. The removable attachment includes a coupling portion including at least one coupling member configured to removably coupled to the vehicle; a material support portion extending from the coupling portion and defining a surface configured to receive cargo; a distribution assembly extending from one of the material support portion and the coupling portion. The distribution assembly includes a moveable arm operable to provide movement along at least two axes, and a coupler extending from the moveable arm, wherein the coupler is positioned to selectively engage and disengage an object for unloading from the material support portion.

According to another example (“Example 18”), further to Example 17, the coupler is electromagnetic and wherein the coupler is configured to electrically couple to an electrical system of the vehicle.

According to another example (“Example 19”), further to Example 17, the material support portion includes at least two forks extending generally horizontally.

According to another example (“Example 20”), further to Example 17, the moveable arm of the distribution assembly supports a camera.

According to another example (“Example 21), further to any one of Examples 1, 9, or 17, the coupler comprises a coupling actuator, the coupling actuator being fluidly coupled to the hydraulic pressure source

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a distribution vehicle with an attachment for distribution of materials or objects at a worksite, in accordance with an embodiment; and

FIG. 2 is a schematic of a distribution vehicle, in accordance with an embodiment;

FIG. 3 is a perspective view of an attachment for distribution of materials or objects at a worksite, in accordance with an embodiment;

FIG. 4 is a front view of the attachment of FIG. 3;

FIG. 5A is a perspective view of an attachment for distribution of materials or objects at a worksite, the attachment including a moveable arm in a first position, in accordance with an embodiment;

FIG. 5B is a perspective view of the attachment of FIG. 5A with the moveable arm in a second position, in accordance with an embodiment;

FIG. 6A is a top view of an attachment for distribution of materials or objects at a worksite, the attachment including a moveable arm in a first position, in accordance with an embodiment;

FIG. 6B is a top view of the attachment of FIG. 5A with the moveable arm in a second position, in accordance with an embodiment;

FIG. 7A is a side view of an attachment for distribution of materials or objects at a worksite, the attachment including a moveable arm in a first position, in accordance with an embodiment;

FIG. 7B is a side view of the attachment of FIG. 5A with the moveable arm in a second position, in accordance with an embodiment; and

FIG. 8 is a manifold, in accordance with an embodiment.

FIG. 9 is a perspective view for distribution of materials or objects at a worksite, in accordance with another embodiment.

FIG. 10 is a perspective view of an example pile for distribution to a target site.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

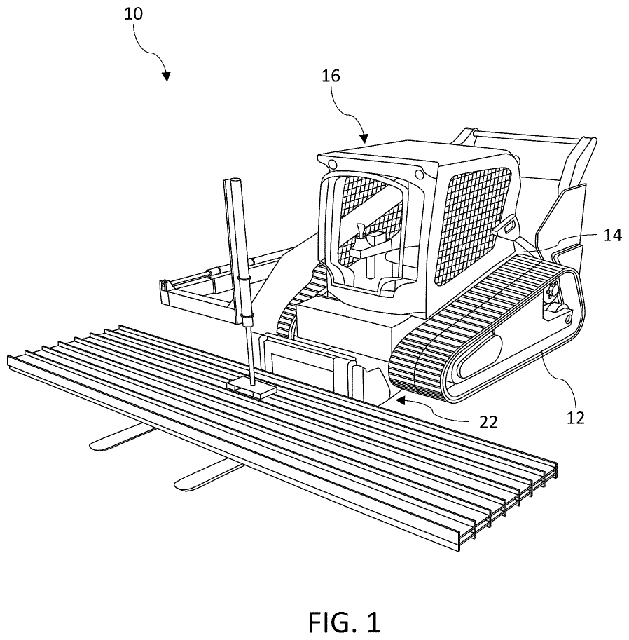

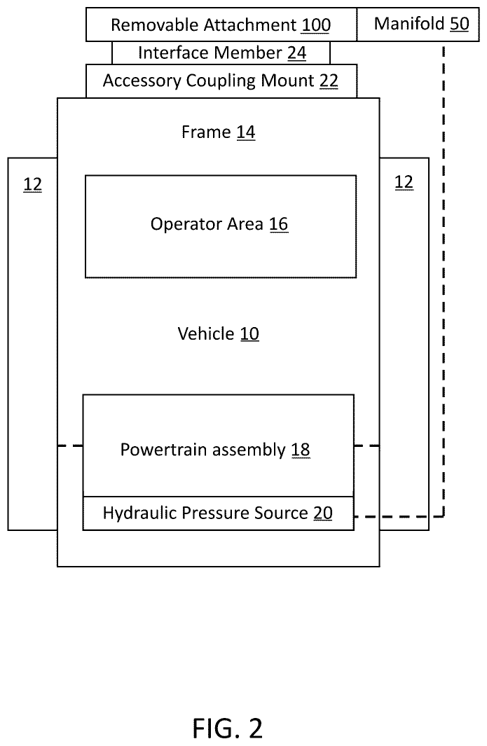

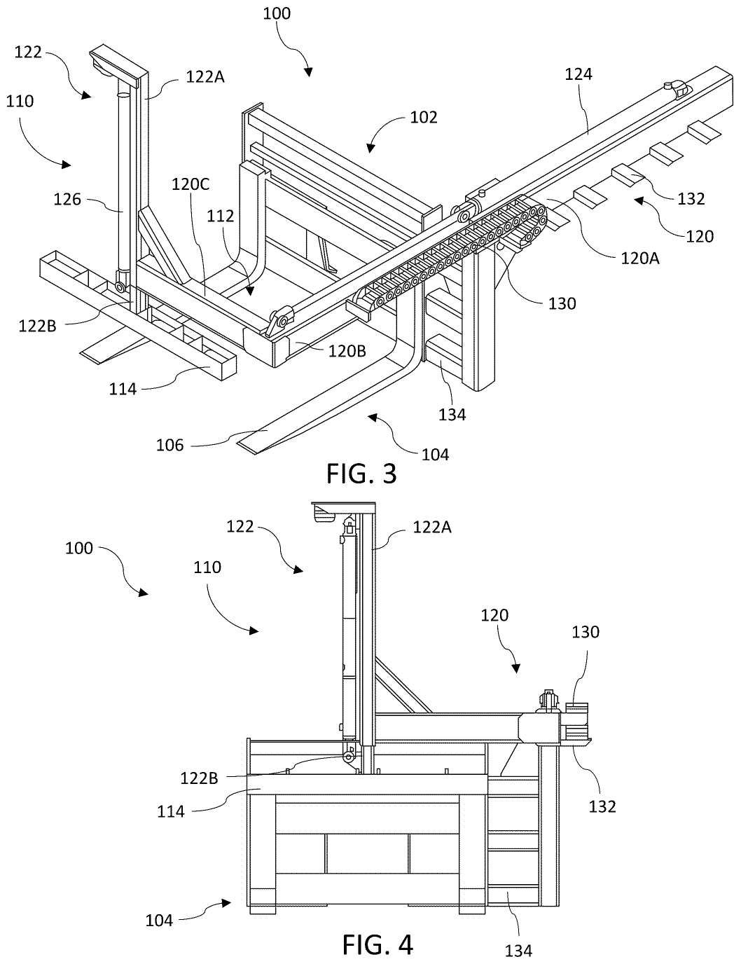

The vehicle shown in FIG. 1 is provided as an example of the various features of the attachment and distribution assembly and, although the combination of those illustrated features is clearly within the scope of invention, that example and its illustration is not meant to suggest the inventive concepts provided herein are limited from fewer features, additional features, or alternative features to one or more of those features shown in FIG. 2 or 3. For example, in various embodiments, the removable attachment of the vehicle shown in FIG. 1 may include the components such as the harness described with reference to FIG. 3. It should also be understood that the reverse is true as well.

Referring to FIG. 1, a vehicle 10 is illustrated with ground engaging members 12 (e.g., tracks, although other ground engaging members such as tires and so forth may be implemented). The vehicle 10 further includes a frame 14 supported by the ground engaging members 12 and which supports an operator area 16, a powertrain assembly 18 (see FIG. 2) operably coupled to the ground engaging member 12, a hydraulic pressure source 20 (see FIG. 2), and an accessory coupling mount 22. The accessory coupling mount 22 may be provided in various forms. For example, on some vehicles, the accessory coupling mount 22 may be provided as a bucket mount, a fork mount, an auger mount, a trencher mount, a broom mount, a blade mount, and so forth. The accessory coupling mount 22 may be fixed or moveable relative to the frame 14. The accessory coupling mount 22 includes at least one interface member 24 (e.g., mount position such as mount plates, brackets, etc.) (see FIG. 2) for coupling an attachment 100 for distribution of materials at a worksite.

Referring to FIG. 3, the attachment 100 for distribution of materials at a worksite is shown as an accessory that is configured to be mounted to the vehicle 10. It is understood that the attachment 100 may be provided as a device or a kit that can be installed onto and removed from the vehicle 10 or the vehicle 10 may be provided with the attachment 100. The attachment 100 includes a coupling portion 102 configured to couple (e.g., removably couple) to the accessory coupling mount 22 (e.g., via the interface member 24 of the vehicle 10). The attachment 100 further includes a material support portion 104 that is configured to support the objects and materials that are to be distributed across the worksite. The material support portion 104 extends from or is coupled to the coupling portion 102. The material support portion 104 defines a surface 106 that is provided to support objects during movement of the vehicle about the worksite. In some embodiments, the coupling portion 102 and material support portion 104 may be provided as a fork attachment that is typically implemented for heavy duty vehicles including, but not limited to, a skid steer, a track steer, a telehandler, or any other construction vehicle with forks. For example, in some embodiments, the forks are rated at 6,000 lbs. In these embodiments, the surface 106 of the material support portion 104 may include the forks of the fork attachment and the coupling portion 102 includes the includes the interface of the fork attachment for coupling to a skid steer or other vehicle.

Referring still to FIG. 3, the attachment 100 includes a distribution assembly 110. The distribution assembly 110 is configured to manipulate the objects and materials at a target site within the work site. More specifically, once the vehicle 10 has arrived approximately at a location at which the object (e.g., a pile) is to be delivered (e.g., a target site), the distribution assembly 110 is operable to take the object from the material support portion 104 and place it at the target site (e.g., on the ground), for installation at a later time. In some examples, the distribution assembly 110 is operable to pick up individual objects and articulate in such as way that the object clears the material support portion 104 for release and placement at the target site.

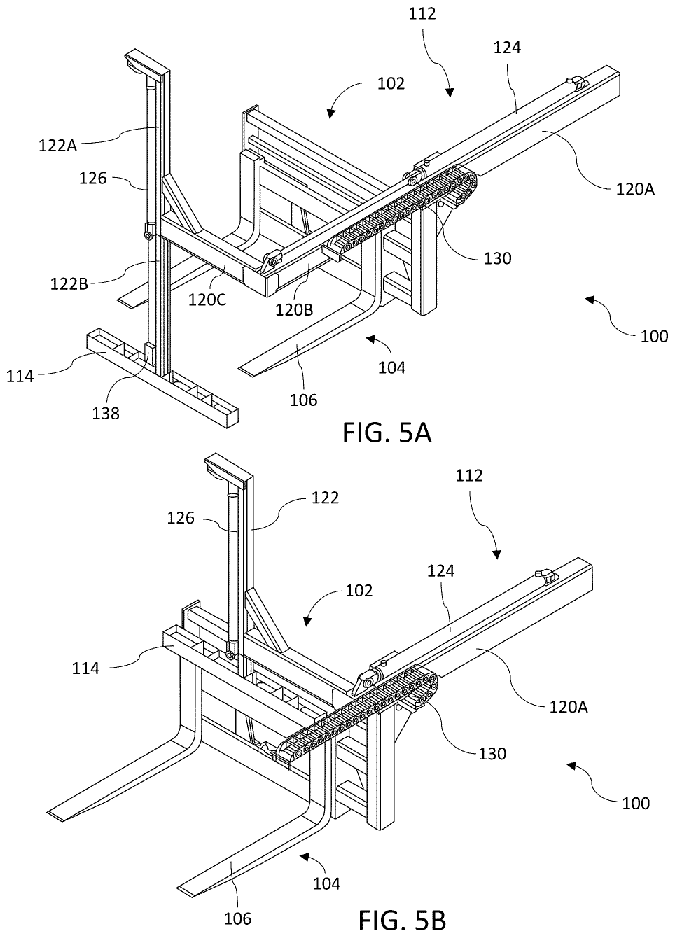

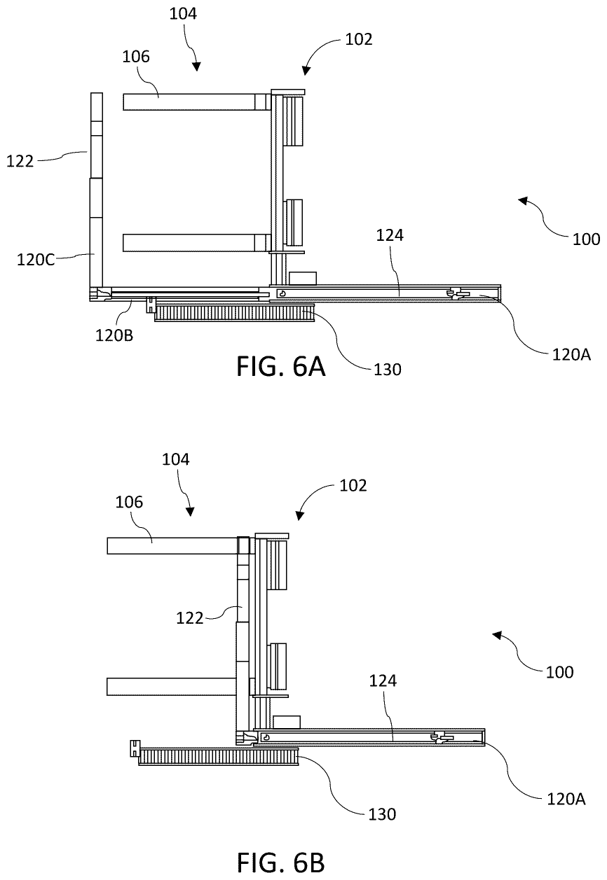

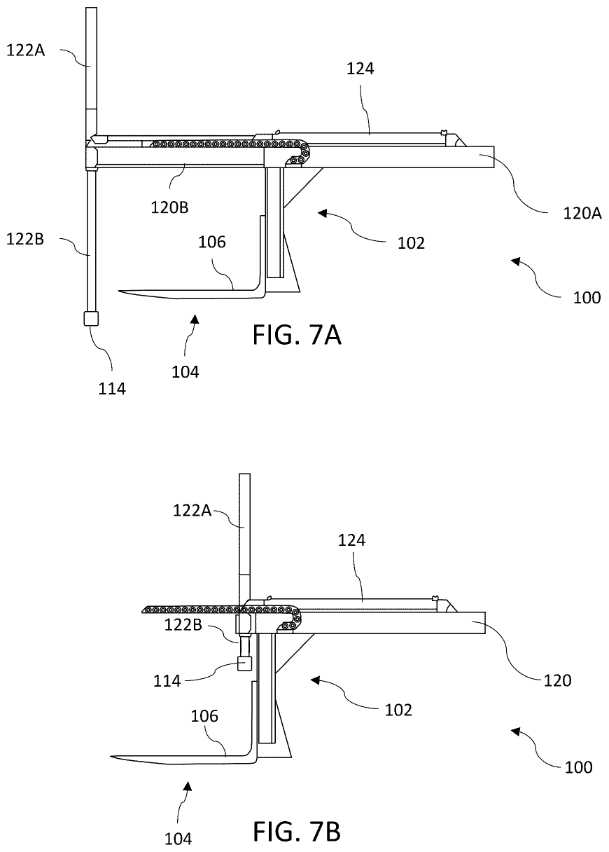

Referring more specifically to the distribution assembly 110, the distribution assembly generally includes a moveable arm 112 and a coupler 114. The moveable arm 112 is configured to articulate relative to the vehicle 10 and the material support portion 104. For example, the moveable arm 112 can move along at least two axes. For example, the moveable arm 112 can move generally vertically and generally horizontally in order to be able to engage with objects on the material support portion 104, to lift the objects, move the objects without contacting the remaining objects on the material support portion 104 to a position where, when released, the objects would clear the vehicle 10, attachment 100, and any material supported on the attachment 100. Movement of the moveable arm 112 can be seen in FIGS. 5A and 5B, 6A and 6B, and 7A and 7B.

Referring first to the coupler 114, the coupler 114 is coupled to or extends from the moveable arm 112, wherein the coupler 114 is positioned to selectively engage and disengage an object for unloading from the material support portion 104. The coupler 114 can be provided in various configuration. In one embodiment, the coupler 114 is an electromagnet which can be selectively activated and deactivated. In some embodiments, the coupler 114 can include a plurality of electromagnets. In some embodiments, each of the plurality of electromagnets are rated for 1,000 lbs. It is within the scope of this disclosure that other couplers such as grips, suction, and so forth may be implemented for grasping or otherwise retaining objects. As shown in FIG. 3, the coupler 114 may include an elongated profile, the elongated profile configured to match at least a portion of a profile of the object to which it couples. For example, the coupler 114 may include the elongated profile to extend along at least a portion of the length of a pile, the elongated profile providing increased area along which a magnetic field may be applied in order to retain the pile. This may be beneficial in situations in which the object to be manipulated is heavy (such as a heavy-duty construction pile) and requires sufficient force to elevate and move the object.

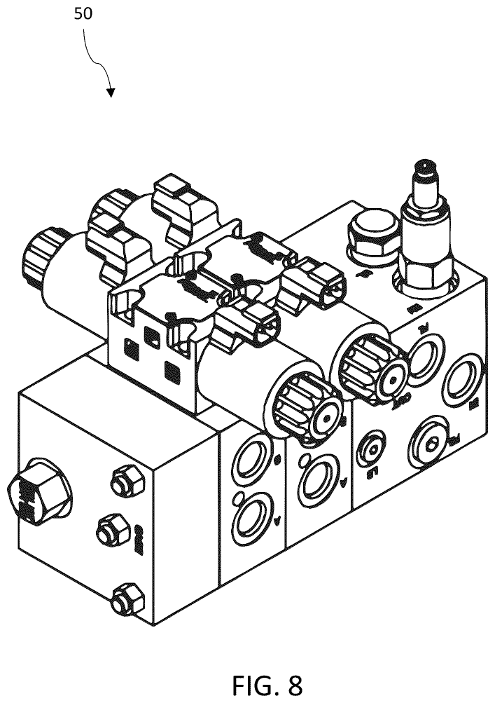

Referring more specifically to the moveable arm 112, the moveable arm 112 may be defined by various components that facilitate movement. In some embodiments, the moveable arm 112 includes a first arm 120 extending in a first direction and a second arm 122 extending in a second direction. The first and second arms 120, 122 are operable to translate along different axes in order to allow movement of the coupler 114 in at least two planes. The movement may be accomplished by providing a first hydraulic actuator 124 coupled to the first arm 120 and operable to linearly translate at least a portion of the first arm 120. In some examples, linearly translating at least a portion of the first arm 120 results in the extension of the first arm 120. The movement may also be accomplished by providing a second hydraulic actuator 126 coupled to the second arm 122 and operable to linearly translate at least a portion of the second arm 122. In some examples, linearly translating at least a portion of the second arm 122 results in the extension of the second arm 122. Each of the first and second hydraulic actuators 124, 126 are removably couplable to the hydraulic pressure source 20 of the vehicle 10 (e.g., via a manifold 50, see FIGS. 2 and 8). The first and second arms 120, 122 may be provided as telescoping parts. For example, the first arm 120 may include a first portion 120B that is slidably received in a second portion 120A, where a first end of the first hydraulic actuator 124 is coupled to the first portion 120B and a second end of the first hydraulic actuator 124 is coupled to the second portion 120A. For example, a square tubing frame may be implemented with the first hydraulic actuator 124 which is a 60-inch-long cylinder having a 48-inch stroke, a 2-inch bore, and is rated for 3,000 psi. Similarly, the second arm 122 may include a first portion 122B that is slidably received in a second portion 122A, where a first end of the second hydraulic actuator 126 is coupled to the first portion 122B and a second end of the second hydraulic actuator 124 is coupled to the second portion 122A. In some examples, each of the first hydraulic actuator 124 and the second hydraulic actuator 126 are each independently operable to extend between an extended and a retracted position. For example, a square or rectangular tubing frame may be implemented with the second hydraulic actuator 126 which is a 46-inch-long cylinder having a 36-inch stroke, a 2-inch bore, and is rated for 3,000 psi. It is understood that any number of portions of the arms may be implemented in a telescopic arrangement. In some embodiments, the first arm 120 may include a third portion 120C that extends in a direction other than along an axis of the first and second portions 120A, 120B. For example, the third portion 120C may extend perpendicularly from the first portion 120A. This allows the first and second portions 120 to be offset such that they are not positioned above the material support portion 104 and does not contact the vehicle 10 when throughout its range of movement.

Referring to FIG. 3, in some embodiments, the distribution assembly 110 includes a harness 130 that maintains the hydraulic and/or electrical lines of the distribution assembly 110. The harness 130 moves and adjusts as the moveable arm 112 articulates. Struts 132 may be provided to support the harness 130 when the moveable arm 112 is in certain positions. The struts 132 extend from the first arm 120. The harness 130 includes various interface members (not shown) which are configured to interface with the systems of the vehicle 10. For example, the interface members may include electrical plugs, hydraulic hose connectors, etc. In some embodiments, the harness 130 may include or otherwise be coupled to the manifold 50. The manifold 50 may be coupled to the hydraulic pressure source 20 via the harness 130 or other hoses. The first and second hydraulic actuators 124, 126 are coupled to the manifold 50 thus distributing the hydraulic pressure to the first and second hydraulic actuators 124, 126 for operation of the distribution assembly 110.

Referring to FIGS. 3 and 4, various support struts 134 are provided to securely couple the moveable arm 112 to the coupling portion 102 and/or the material support portion 104. The struts 134 allow the coupling portion 102 and/or the material support portion 104 and minimize torsion of the moveable arm 112 during movement of the materials and/or objects. Additional brackets may be provided throughout to strengthen or otherwise support joints or components throughout the attachment 100.

In some embodiments, the attachment 100 includes at least one camera 136. The various cameras 136 may be implemented to facilitate field of view and precise operation of the distribution assembly 110. For example, a camera 136 may be supported on the second arm 122 (see FIG. 5A). This allows the operator to see operation of the distribution assembly 110 (e.g., allows the operator to view the coupler 114 and the object during pick up). Additional cameras may be placed about the attachment 100 and vehicle 10 for safe and precise operation of the vehicle 10 and the distribution assembly 110 from the operator area 16. The operator area 16 may include a control system or panel that allows for control of the distribution assembly 110 and the other components of the vehicle 10 from a centralized and safe location.

Referring to FIG. 8, the manifold 50 is shown for reference.

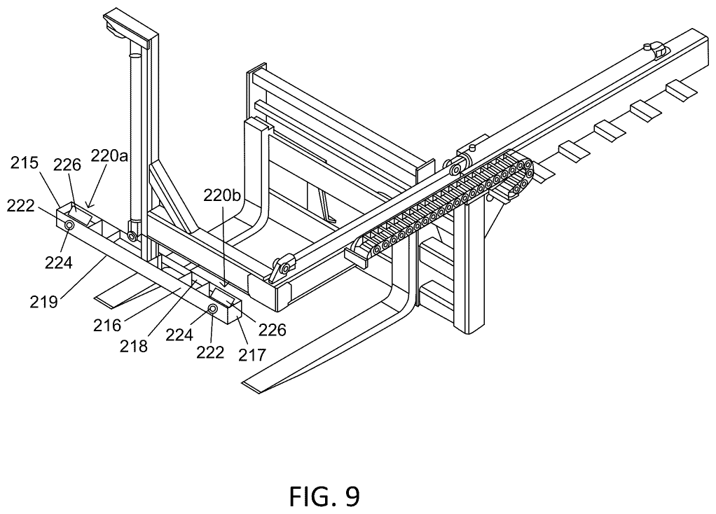

FIG. 9 is a side view of another example attachment 200. In some examples, the attachment 200 is similar in many aspects to the attachment 100. In some examples, like the attachment 100, the attachment 200 includes a coupler 214.

In some examples, the coupler 214 comprises a coupler body 219, with a front face 216 opposite a rear face 218 and one or more coupling actuators 220.

In some examples, the coupler body 219 is an elongate body that extends between a left end 215 to a right end 217 of the attachment 200. In some examples, the coupler body 219 comprises an internal space between the front face 216 and the rear face 218. In some examples, the coupler body 219 houses the one or more coupling actuators 220.

In some examples, the front face 216 and the rear face 218 of the coupler body 219 are substantially parallel. One or more of the front face 216 and the rear face 218 comprise an actuator opening 222. In some examples, the actuator opening 222 comprises a hole formed through the one or more of the front face 216 or the rear face 218

In some examples, the coupling actuator 220 of the coupler 214 comprises a first piston 224 and an actuator body 226. In some examples, the coupling actuator 220 further comprises a second piston 228 (not pictured). In some examples, the first piston 224 is configured to be arranged substantially completely within the coupler body 219 when in a retracted state and is configured to extend through an actuator opening 222 in the front face 216 of the coupler body 219 in an extended state. In some examples, the second piston 228 is configured to be arranged substantially completely within the coupler body 219 when in a retracted state and is configured to extend through an actuator opening 222 in the rear face 218 of the coupler body 219 in an extended state. In some examples, the actuator body 226 comprises two separate actuator bodies, one for housing the first piston 224 and another for housing the second piston 228. In some examples, the first piston 224 comprises a pancake cylinder. In some examples, the second piston 228 also comprises a pancake cylinder.

In some examples, the coupling actuator 220 comprises a first coupling actuator 220a and a second coupling actuator 220b. In some examples, the first coupling actuator 220a is arranged proximate the left end 215 of the coupler body 219 and the second coupling actuator 220b is arranged proximate the right end 217 of the coupler body 219. In some examples, the coupling actuator 220 comprises one or more additional coupling actuators 220 arranged between the first coupling actuator 220a and the second coupling actuator 220b.

In some examples, coupling actuators 220 are pneumatically powered. In other examples the coupling actuators 220 are hydraulically powered. In some examples, the coupling actuators 220 are removably couplable to the hydraulic pressure source 20 of the vehicle 10 (e.g., via a manifold 50, see FIGS. 2 and 8).

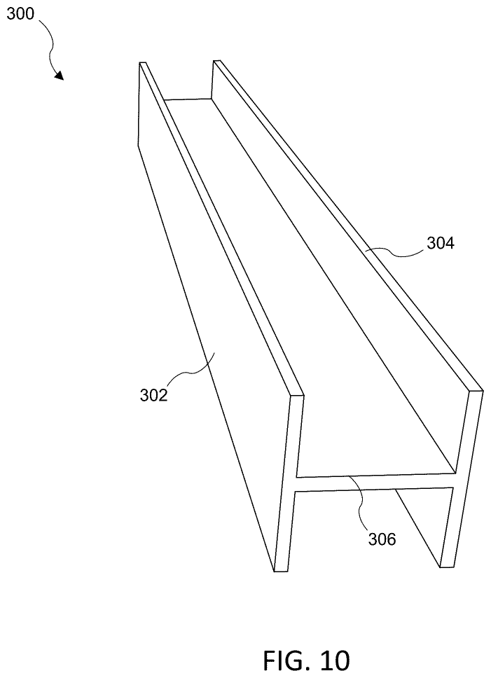

FIG. 10 is an example pile 300 that can be moved using the attachment 100 or the attachment 200 to a target site. In some examples, the pile 300 comprises a first flange 302, a second flange 304, and a web flange 306 that extends between and connects the first flange 302 and the second flange 304.

In some examples, the pile 300 is connected to the attachment 100, 200 by the coupler 114, 214. In some examples, the coupler 114, 214 is inserted into the space between the first flange 302 and the second flange 304 of the pile 300, at which point it is configured to connect to the pile.

In some examples, once the coupler 214 is inserted into the space between the first flange 302 and the second flange 304 of the pile 300, the one or more coupling actuators 220 of the coupler 214 are actuatable by a user to be moved into the extended state such that the pistons 224, 228 extend out from the front face 216 and the rear face 218 of the coupler body 219 and contact the first flange 302 and the second flange 304 of the pile 300. In some examples, the one or more coupling actuators 220 are configured to generate a compression force against the first flange 302 and the second flange 304 of the pile 300. In some examples, the compression force generated by the one or more coupling actuators 220 generates sufficient friction between the one or more pistons 228, 228 and the first flange 302 and the second flange 304 of the pile 300 such that the pile 300 may be lifted while the one or more coupling actuators 220 are generating the compression force. In some examples, the one pile 300 may then be moved by the attachment 200 to a point where it is no longer positioned over the surface 106 and the coupling actuators 220 may be moved into the retracted position, at which point the pile 300 is de-coupled from the coupler 214.

While various actuators referenced throughout the above disclosure are described as hydraulic actuators, any one or more of the actuators may be alternatively constructed using linear screws powered by hydraulic motors. Likewise, any one or more of the actuators may be constructed using linear screws powered by electric motors. In such examples, an alternate power supply may be provided to power the electric motors.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A removable attachment configured to be removably coupled to a vehicle for distribution of a plurality objects at a worksite, the vehicle including an accessory coupling mount and a hydraulic pressure source, the removable attachment comprising:
a coupling portion including at least one coupling member configured to removably coupled to the accessory coupling mount of the vehicle;
a material support portion extending from the coupling portion, the material support portion defining a surface operable to support the objects during movement of the vehicle;
a distribution arm assembly extending from one of the material support portion and the coupling portion, the distribution arm assembly including:
a first arm extending in a first direction;
a first hydraulic actuator coupled to the first arm and operable to linearly translate at least a portion of the first arm, the first hydraulic actuator fluidly coupled to the hydraulic pressure source;
a second arm extending from the first arm generally in a second direction that is different from the first direction;
a second hydraulic actuator coupled to the second arm and operable to linearly translate at least a portion of the second arm, the second hydraulic actuator fluidly coupled to the hydraulic pressure source; and
a coupler extending from the second arm, wherein the coupler is positioned to selectively interface an object of the plurality of objects.

2. The removable attachment of claim 1, wherein the coupler is electromagnetic and wherein the coupler is configured to electrically couple to an electrical system of the vehicle.

3. The removable attachment of claim 1, wherein the coupler comprises a coupling actuator, the coupling actuator fluidly coupled to the hydraulic pressure source.

4. The removable attachment of claim 1, wherein the material support portion includes at least two forks extending generally horizontally.

5. The removable attachment of claim 1, wherein the second arm of the distribution assembly supports a camera.

6. The removable attachment of claim 1, wherein the distribution assembly includes a harness operable to maintain hydraulic and electrical lines.

7. The removable attachment of claim 1, further comprising a manifold system fluidically coupled to the first hydraulic actuator and the second hydraulic actuator and operable to coupled to the hydraulic pressure source of the vehicle.

8. The removable attachment of claim 1, further comprising a control system operable to control the distribution assembly and configured to be electrically coupled to an electrical system of the vehicle.

9. A vehicle for distribution of a plurality objects at a worksite, the vehicle comprising:
a plurality of ground engaging members;
a frame supported by the ground engaging members;
a powertrain assembly supported by the frame and operably coupled to at least one of the ground engaging members;
a hydraulic pressure source supported by the frame and including a coupling member;
an accessory coupling mount supported by the frame; and
a removable attachment assembly supported by the frame, the removable attachment assembly including:
a coupling portion including at least one coupling member configured to removably coupled to the accessory coupling mount of the vehicle;
a material support portion extending from the coupling portion, the material support portion defining a surface operable to support the objects during movement of the vehicle;
a distribution assembly extending from one of the material support portion and the coupling portion, the distribution assembly including:
a first arm extending in a first direction,
a first hydraulic actuator coupled to the first arm and operable to linearly translate at least a portion of the first arm, the first hydraulic actuator fluidly coupled to the hydraulic pressure source,
a second arm extending from the first arm generally in a second direction that is different from the first direction,
a second hydraulic actuator coupled to the second arm and operable to linearly translate at least a portion of the second arm, the second hydraulic actuator fluidly coupled to the hydraulic pressure source, and
a coupler extending from the second arm, wherein the coupler is positioned to selectively interface an object of the plurality of objects.

10. The vehicle of claim 9, wherein the coupler is electromagnetic and wherein the coupler is configured to electrically couple to an electrical system of the vehicle.

11. The vehicle of claim 9, wherein the coupler comprises a coupling actuator, the coupling actuator fluidly coupled to the hydraulic pressure source.

12. The vehicle of claim 9, wherein the material support portion includes at least two forks extending generally horizontally.

13. The vehicle of claim 9, wherein the second arm of the distribution assembly supports a camera.

14. The vehicle of claim 9, wherein the distribution assembly includes a harness operable to maintain hydraulic and electrical lines.

15. The vehicle of claim 9, further comprising a manifold system fluidically coupled to the first hydraulic actuator and the second hydraulic actuator and operable to coupled to the hydraulic pressure source of the vehicle.

16. The vehicle of claim 9, further comprising a control system operable to control the distribution assembly and configured to be electrically coupled to an electrical system of the vehicle.

17. A removable attachment for a vehicle, comprising:
a coupling portion including at least one coupling member configured to removably coupled to the vehicle;
a material support portion extending from the coupling portion and defining a surface configured to receive cargo;
a distribution assembly extending from one of the material support portion and the coupling portion, the distribution assembly including:
a moveable arm operable to provide movement along at least two axes, and
a coupler extending from the moveable arm, wherein the coupler is positioned to selectively engage and disengage an object for unloading from the material support portion.

18. The removable attachment of claim 17, wherein the coupler comprises a coupling actuator, the coupling actuator fluidly coupled to the hydraulic pressure source.

19. The removable attachment of claim 17, wherein the material support portion includes at least two forks extending generally horizontally.

20. The removable attachment of claim 17, wherein the moveable arm of the distribution assembly supports a camera.
